(19) United States
(12) Patent Application Publication
(10) Pub. No.: US 2023/0196272 A1
(43) Pub. Date: Jun. 22, 2023

(54) WAYPOINT DETERMINATION SYSTEM AND METHOD

(71) Applicant: DoorDash, Inc., San Francisco, CA (US)

(72) Inventors: Sushil Vellanki, Dublin, CA (US); Chi Zhang, San Jose, CA (US); Xun Liu, San Jose, CA (US); Eric Pan, San Francisco, CA (US)

(73) Assignee: DoorDash, Inc., San Francisco, CA (US)

(21) Appl. No.: 18/063,549

(22) Filed: Dec. 8, 2022

Related U.S. Application Data
(60) Provisional application No. 63/292,182, filed on Dec. 21, 2021.

(51) Int. Cl. G06Q 10/0835; G01C 21/34

(52) U.S. Cl. CPC G06Q 10/08355; G01C 21/34

(57) ABSTRACT

A method includes receiving, by a computer, a destination address. The computer can obtain historical fulfillment data for the destination address. The computer can then determine one or more temporary transporter locations based on the historical fulfillment data for the destination address. The computer can determine a waypoint location from the one or more temporary transporter locations. The computer can provide the waypoint location.

### CROSS-REFERENCES TO RELATED APPLICATIONS

This application is a non-provisional application of and claims the benefit of U.S. provisional application No. 63/292,182, filed on Dec. 21, 2021, which is herein incorporated by reference in its entirety for all purposes.

### SUMMARY

One embodiment is related to a method comprising: receiving, by a computer, a destination address; obtaining, by the computer, historical data of transporters that previously delivered items to the destination address; determining, by the computer, one or more temporary transporter locations based on the historical data; determining, by the computer, a waypoint location from the one or more temporary transporter locations; and providing, by the computer, the waypoint location.

Another embodiment is related to a computer comprising: a processor; and a non-transitory computer-readable medium coupled to the processor, the non-transitory computer-readable medium comprising code executable by the processor for performing operations comprising: receiving a destination address; obtaining historical data of transporters that previously delivered items to the destination address; determining one or more temporary transporter locations based on the historical data; determining a waypoint location from the one or more temporary transporter locations; and providing the waypoint location.

Another embodiment of the invention includes a system comprising: a computer comprising: a processor; and a computer-readable medium coupled to the processor, the computer-readable medium comprising code executable by the processor for implementing a method comprising: receiving a destination address; obtaining historical data of transporters that previously delivered items to the destination address; determining one or more temporary transporter locations based on the historical data; determining a waypoint location from the one or more temporary transporter locations; and providing the waypoint location to a user device used by a transporter; wherein determining the one or more temporary transporter locations further comprises: performing, by the computer, a machine learning clustering process to cluster the historical data associated with the destination address to obtain the one or more temporary transporter locations, wherein the historical data comprises location data of transporter user devices used by transporters that are temporarily motionless, wherein the location data comprises the latitude and longitude of the transporter user devices; and wherein determining the waypoint location from the one or more temporary locations comprises: determining, by the computer, a motion type for each temporary transporter location of the one or more temporary transporter locations; determining, by the computer, a tag for each temporary transporter location based on the motion type; and if the tag for a temporary transporter location meets waypoint location criteria, then determining that the temporary transporter location is a waypoint location; and the user device.

Further details regarding embodiments of the disclosure can be found in the Detailed Description and the Figures.

### BRIEF DESCRIPTION OF THE DRAWINGS

FIG. 1 shows a block diagram of a fulfillment system according to embodiments.

FIG. 2 shows a block diagram of components of a central server computer according to embodiments.

FIG. 3 shows a block diagram of components of a location evaluation computer according to embodiments.

FIG. 4 shows a block diagram of a user device according to embodiments.

FIG. 5 shows a flow diagram illustrating a waypoint location determination method according to embodiments.

FIG. 6 shows a flow diagram of a machine learning clustering method according to embodiments.

FIG. 7 shows an illustration of clustered data and determined temporary transporter location according to embodiments.

FIG. 8 shows an illustration of a navigational path with and without a temporary transporter location according to embodiments.

FIGS. 9A-C show illustrations of navigating to a destination location in a limited access area according to embodiments.

FIG. 10 shows an illustration of a user interface illustrating a destination location, a current location, and a waypoint location pinned on a map according to embodiments.

FIGS. 11A-C show illustrations of navigating to a hospital according to embodiments.

FIG. 12 shows an illustration of a shared waypoint according to embodiments.

### DETAILED DESCRIPTION

User devices such as mobile phones use navigation applications (e.g., Google Maps™) to guide a person delivering an item to an end user from a starting destination to an ending destination. While conventional navigation applications are useful, they can be improved. For instance, some trips may require two modes of travel (e.g., by car and walking) and/or may require a waypoint (e.g., a temporary stopping point for a car, so that a transporter of an item can make a delivery). Current navigation applications do not provide for sufficient information to optimize trips of this type.

The inability of current navigation applications to efficiently route users during trips of this type can be problematic, can cause delays in the delivery and receipt of items, and can unnecessarily consume network resources. For example, a trip that a transporter takes to make a delivery of an item to an end user may require that the transporter travel through congested city streets. If the transporter is not familiar with the area, the transporter may spend a significant amount of time trying a locate a place to temporarily stop their transporter vehicle to deliver the item to the end user. This can unnecessarily consume computer network resources. For example, if the transporter is continually looking for a place to temporarily stop their transporter vehicle when delivering an item to an end user, then the navigation application that the user is using will continue to re-adjust and re-route the transporter to the end destination. The inability to quickly locate a suitable temporary stopping point can also waste the time of the transporter and can delay the delivery of the item to the end user. It can also result in unnecessary carbon emissions from transporters. Lastly, if the transporter cannot locate a suitable place to temporarily stop (e.g., parks) and make the intended delivery, the transporter may temporarily stop their transporter vehicle in a location that may be unlawful (e.g., a no parking zone) or unsafe. This not desirable.

Embodiments of the disclosure address this problem and other problems individually and collectively.

Prior to discussing embodiments of the disclosure, some terms can be described in further detail.

An “item” can be an individual article or unit. Examples of items can include perishable items such as food items, beauty items (e.g., cosmetics), office supply products (e.g., staples, paper, and ink), hardware items (e.g., nails, hammers, wrenches), electronic devices (e.g., computers, phones, jewelry, etc.

A “user” may include an individual or an entity. In some embodiments, a user may be associated with one or more personal accounts and/or mobile devices. In some embodiments, the user may be a consumer.

A “user device” may be any suitable electronic device that can be used by a user. An exemplary user device can process and communicate information to other electronic devices. The user device may include a processor and a computer-readable medium coupled to the processor, the computer-readable medium comprising code, executable by the processor. The user device may also each include an external communication interface for communicating with other entities. Examples of user devices may include mobile devices such as mobile phones and laptop computers, wearable devices (e.g., glasses, rings, watches, etc.), hardware modules in larger devices such as vehicles (e.g., automobiles), etc.

A “server computer” can be a powerful computer or cluster of computers. For example, the central server computer can be a large mainframe, a minicomputer cluster, or a group of servers functioning as a unit. In one example, the central server computer may be a database server coupled to a Web server. The central server computer may also be a cloud based server.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “fulfillment request” can be a request to provide one or more items. For example, a fulfillment request can include an initial communication from an end user device to a central server computer for a service provider computer to fulfill a purchase request for an item such as food.

A “transporter” can be an entity that transports something. For example, a transporter can be a person that transports an item using a transporter vehicle (e.g., a car). In other embodiments, a transporter can be a transporter vehicle that may or may not be operated by a human. Examples of transporter vehicles include cars, boats, scooters, bicycles, drones, airplanes, etc.

“Machine learning” can include an artificial intelligence process in which software applications may be trained to make accurate predictions through learning. The predictions can be generated by applying input data to a predictive model formed from performing statistical analyses on aggregated data.

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs.

Embodiments provide for a method that can allow for the determination of a waypoint location using historical transporter data associated with a destination address of an end user. A transporter can use the waypoint location when delivering an item to an end user from a starting location to the destination address. The transporter can use the waypoint location to temporarily stop and locate their transporter vehicle. Once the transporter vehicle is stopped, the transporter can deliver the item to the end user through another mode of travel (e.g., walking). For example, a waypoint location can be a parking spot location that is close to an end user's location during a trip to deliver an item from a service provider (e.g., a restaurant) to the end user's location (e.g., the end user's home). The transporter can operate a transporter vehicle such as a car and can park the car in the parking spot location. Once parked, the transporter can walk to the end user's location and deliver the item to the end user.

Embodiments can utilize location data (e.g., latitude, longitude, etc.) and motion types (e.g., driving, cycling, walking, stationary, etc.) to identify and characterize “hotspots” or “temporary transporter locations.” These may be locations along a delivery route where transporters may temporarily spend more time, such as when they are making deliveries or picking up goods to be delivered. Hotspots are typically characterized by locations where many transporters temporarily stop (e.g., 1-10 minutes) when making deliveries to destination locations. The hotspot locations can then be tagged with one or more motion types. For example, a hotspot can be tagged with the motion types “driving and walking” if prior transporter user device motion data associated with that hotspot indicates that a substantial number of transporters are driving and then subsequently walking at the hotspot.

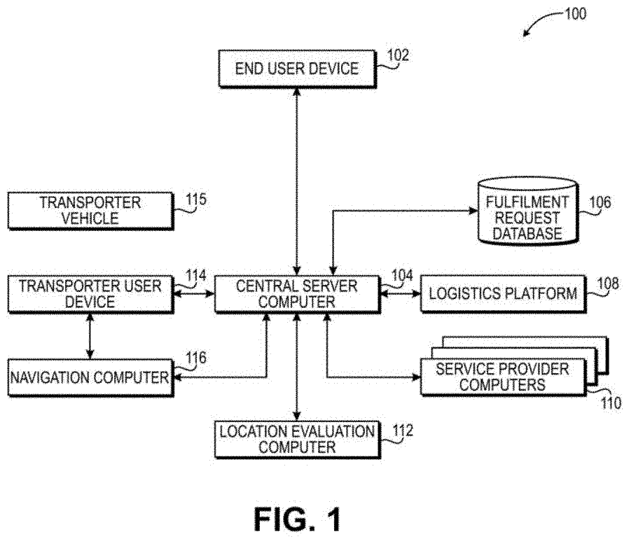

FIG. 1 shows a system 100 according to embodiments. The system 100 comprises an end user device 102, a central server computer 104, a fulfillment request database 106, a logistics platform 108, one or more service provider computers 110, a location evaluation computer 112, a transporter user device 114 and a transporter vehicle 115 operated by a transporter, and a navigation computer 116. If the transporter is a human, then the transporter can operate the transporter user device 114 and the transporter vehicle 115. If the transporter is an autonomous vehicle and is the transporter vehicle 115, then the transporter user device 114 can be part of the transporter vehicle 115.

The central server computer 104 can be in operative communication with the one or more end user devices 102, the fulfillment request database 106, the logistics platform 108, the one or more service provider computers 110, the location evaluation computer 112, the transporter user device 114, and in some embodiments, the navigation computer 116. Further, the one or more transporter user devices 114 can be in operative communication with the navigation computer 116.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. For example, although one end user device 102, one transporter user device 114, and one transporter vehicle 115 are shown in FIG. 1, it is understood that embodiments can include many end user devices, many transporter user devices, and many transporter vehicles.

Messages between at least the devices in the system 100 in FIG. 1 can be transmitted using a secure communications protocol such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The end user device 102 can include a device operated by an end user. The end user device 102 can generate and provide request messages to the central server computer 104. An example of a request message can be a fulfillment request message. The fulfillment request message can indicate that the request (e.g., a request for a service) can be fulfilled by one or more service provider computers 110. In some embodiments, the end user devices 102 can be operated by end users that wish to purchase items (e.g., food) from merchants (e.g., restaurants) operating the service provider computers 110.

The central server computer 104 includes a server computer that can facilitate the fulfillment of fulfillment requests received from the one or more end user devices 102. For example, the central server computer 104 can identify one or more transporters operating one or more transporter user devices 114 that are capable of satisfying the fulfillment request. The central server computer 104 can identify the transporters that can satisfy the fulfillment request based on any suitable criteria (e.g., transporter location, service provider location, end user destination, transporter mode of transportation, etc.). The logistics platform 108 may provide real time data regarding locations of the various service providers, transporters, and end users to the central server computer 104.

The fulfillment request database 106 can store data related to previous (e.g., historical) fulfillment requests. For example, after a fulfillment request, initiated by an end user device 102, is fulfilled, the central server computer 104 can store fulfillment request data into the fulfillment request database 106. For example, the central server computer 104 can store any spatial-temporal fulfillment data (e.g., transporter user device locations over time, transporter user device motion data over time, lengths of time taken to fulfill the fulfillment request, fulfillment locations, end user locations, location data and motion data at regular time points (e.g., every 10 seconds, 15 seconds, 30 seconds, every minute, etc.) along the transporters' trips to their end destinations, etc.), fulfillment service data (e.g., fulfilled services, an amount, a service provider computer identifier, an end user device identifier, a transporter user device identifier, etc.), and any other data relating to fulfillment requests.

The one or more service provider computers 110 include computers operated by service providers. For example, a service provider computer can be a food provider computer that is operated by a food provider such as a restaurant. Other service providers can be retail stores that sell goods such as hardware supplies, cosmetics, etc. The one or more service provider computers 110 can offer to provide services or goods to the end users of the one or more end user devices 102.

The location evaluation computer 112 can be a computer programmed to evaluate locations. The location evaluation computer 112 can evaluate any spatial-temporal data (e.g., location data vs. time, motion data vs. time, etc.) related to a current fulfillment request as well as historical fulfillment requests. In some embodiments, the central server computer 104 can provide fulfillment request data from the fulfillment request database 106 to the location evaluation computer 112. In other embodiments, the location evaluation computer 112 can communicate directly with the fulfillment request database 106 to retrieve spatial-temporal data used to identify waypoint locations.

The one or more transporter user devices 114 can be devices operated by transporters. The one or more transporter user devices 114 can be, for example, smartphones, wearable devices, etc. A transporter can use the transporter user device 114 to submit an acceptance to fulfill an end user's fulfillment request. For example, after receiving an invitation to fulfill an end user's fulfillment request from the central server computer 104, the transporter can interact with the transporter user device 114 to cause it to generate and transmit a message indicating acceptance to fulfill a particular end user's fulfillment request to the central server computer 104.

The navigation computer 116 can provide navigational data to the one or more transporter user devices 114. In some embodiments, the navigation computer 116 can be an application server that interacts with an application on the transporter user device 114 to provide maps and routing instructions based on data provided by the central server computer 104.

Although a specific computer architecture is shown in FIG. 1, it is understood that embodiments of the invention are not limited thereto. For example, although the logistics platform 108, the location evaluation computer 112, and the navigation computer 116 are shown as being separate from the central server computer 104, any or all of them could alternatively be software modules within the central server computer 104.

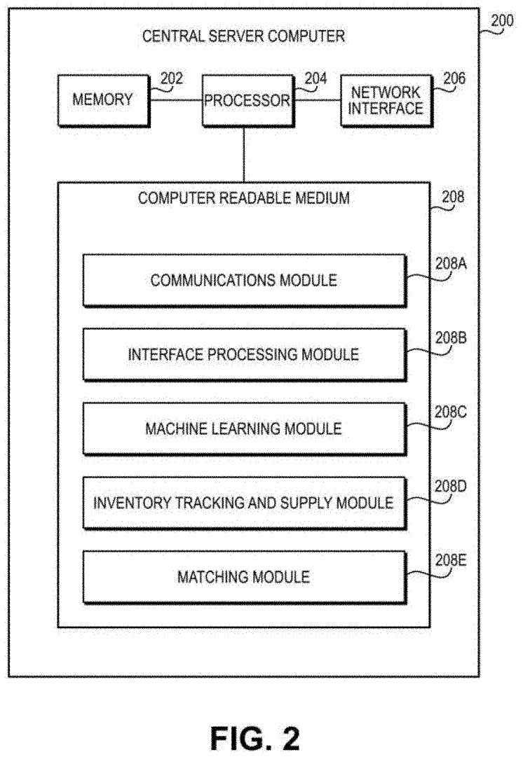

FIG. 2 shows a block diagram of a central server computer 200 according to embodiments. The exemplary the central server computer 200 may comprise a processor 204. The processor 204 may be coupled to a memory 202, a network interface 206, and a computer readable medium 208.

The memory 202 can be used to store data and code. The memory 202 may be coupled to the processor 204 internally or externally (e.g., cloud based data storage), and may comprise any combination of volatile and/or non-volatile memory, such as RAM, DRAM, ROM, flash, or any other suitable memory device. For example, the memory 202 can store communication routing data, user fulfillment request data, location data, etc.

The computer readable medium 208 may comprise code, executable by the processor 204, for performing any method described herein. The computer readable medium 304 may be a non-transitory computer readable medium and can comprise several software modules including, but not limited to, a communication module 208A, an interaction processing module 208B, a machine learning module 208C, an inventory tracking and supply module 208D, and a matching module 208E.

The communication module 208A in conjunction with the processor 302 can allow the central server computer 200 to communicate with various entities (e.g., user devices, server provider computers, etc.). The communications module 208A can include various APIs, and communication and security protocols to allow for such communications.

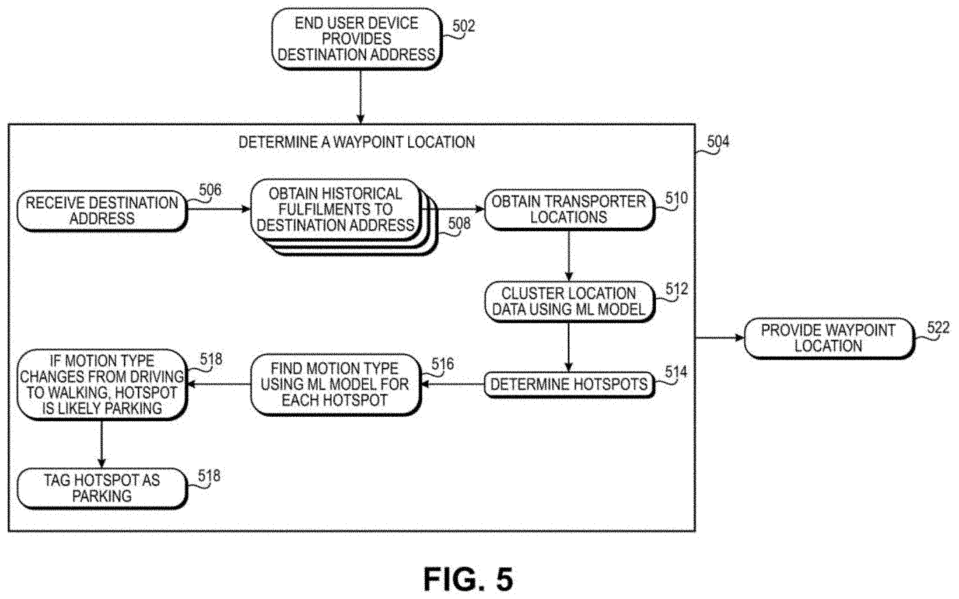

The interaction processing module 208B can comprise code, executable by the processor 302 to perform interactions (e.g., transactions) between service providers and end users. The interaction processing module 208B may comprise code, executable by the processor 302, to present items and service providers to end users via applications on end users' mobile devices, and then receive selections of items by end users and processing orders for the selected items. An example of a user interface that can be facilitated by the interaction processing module 208B is shown in FIG. 5. The interaction processing module 208B and the processor 302 can also coordinate payments between the end users, their financial institutions, and the various service providers involved in the interactions.

The machine learning module 208C, in conjunction with the processor 302, can perform one or more machine learning processes using one or more machine learning models to perform predictions. For example, the machine learning module 208C and the processor 302 can predict a number of outcomes including bundles of items from different service providers that might be purchased by end users. The machine learning module 305C may encode, train, and update a machine learning model based at least on past order data of end users.

The inventory tracking and supply module 208D in conjunction with the processor 302 can monitor the storage capacity at various service provider and intermediate locations. As noted above, the information regarding the storage capacity at the service providers and intermediate locations can be used to determine the quantities of items that are to be supplied from the service providers to other service provider locations or intermediate locations to prepare for the fulfillment of predicted bundles of items that may be purchased by end users. The inventory tracking and supply module 208D can also monitor the number and types of items that are stored at any location in real time. It can also keep track of the age of the stored items so that real time determinations can be made as to whether delivery of such items is still possible or desirable without degrading the quality of the items. In this regard, the items could be provided with machine readable codes (barcodes) which can be linked to information about the origin and creation of the items. These codes can be scanned at the storage locations and can be provided to the central server computer 300. The inventory tracking and supply module 208D and the processor 302 can use this information to manage the inventories of the items at the different locations.

The matching module 208E, in conjunction with the processor 302, can determine a subset of potential transporters which can deliver items or bundles of items to different end users, and can offer the potential orders to the transporters which the transporters may then accept. The matching module 208E and the processor 204 may coordinate with the logistics platform 120 to identify the locations of the service providers and/or intermediate locations that may be involved in an interaction, and the subset of transporters that may be capable of delivering the items for the interaction.

The network interface 206 may include an interface that can allow the central server computer 200 to communicate with external computers. The network interface 206 may enable the central server computer 200 to communicate data to and from another device (e.g., one or more end user devices, a historical delivery database, a logistics platform, one or more service provider computer, a location evaluation computer, one or more transporter user devices, a navigation computer, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

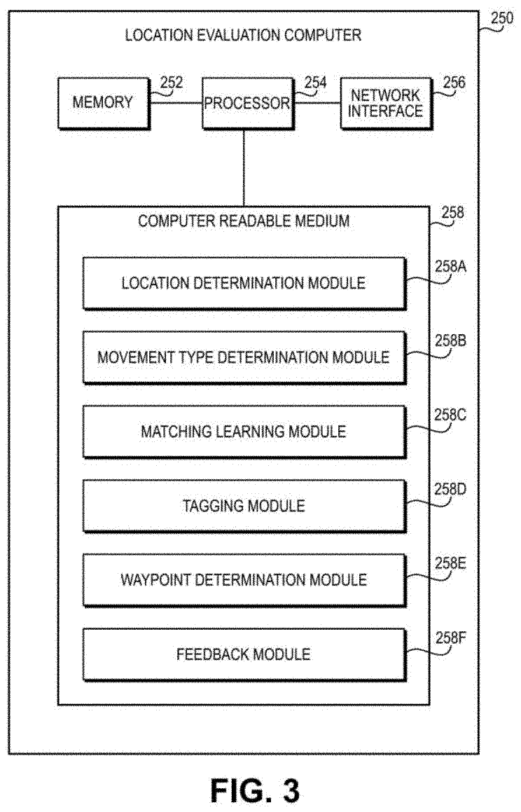

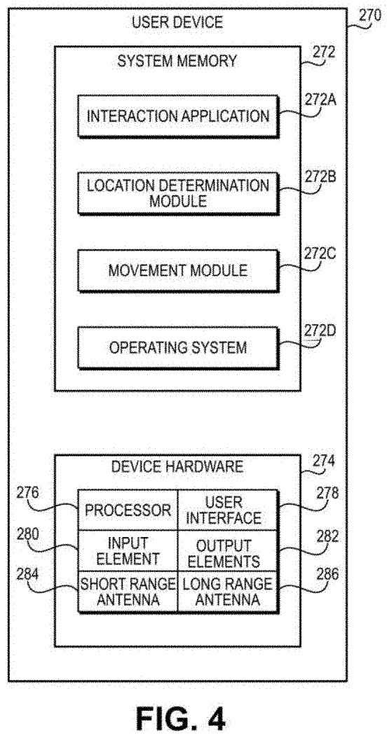

FIG. 3 shows a block diagram of location evaluation computer 250 according to embodiments. The exemplary the location evaluation computer 250 may comprise a processor 254. The processor 254 may be coupled to a memory 252, a network interface 256, and a computer readable medium 258.

The memory 252 can be used to store data and code. The memory 252 may be coupled to the processor 254 internally or externally (e.g., cloud based data storage), and may comprise any combination of volatile and/or non-volatile memory, such as RAM, DRAM, ROM, flash, or any other suitable memory device. For example, the memory 252 can store location data.

The computer readable medium 258 may comprise a number of software modules. In some embodiments, the software modules can include a location determination module 258A, a movement type determination module 258B, a machine learning module 258C, a tagging module 258D, a waypoint determination module 258E, and a feedback module 258F.

The location determination module 258A, in conjunction with the processor 254, can determine a location of a user device, user, or transporter vehicle. In some embodiments, the location determination module 258A and the processor 254 can receive location data associated with transporter user devices from the above-described navigation network or it may determine the location of the transporter user devices on its own. In some embodiments, the location data of the transporter user devices received or determined by the location determination module 258A and the processor 254 can be in the form of latitude and longitudinal coordinates. The location determination module 258A and the processor 254 can also store, for each destination address and for each transporter, the locations of the transporter's user device at period time points from a starting address (e.g., a restaurant location) to an end address (e.g., an end consumer home location) during a trip in a database or memory. In some embodiments, timestamps and locations from the trip can be stored in the database and memory.

The movement type determination module 258B and the processor 254 can determine a movement type associated with a transporter user device. In some embodiments, the transporter user device may have an accelerometer and/or gyroscope and provide accelerometer data to the location evaluation computer 250 (e.g., directly or via the central server computer). In some embodiments, the movement type determination module 258B and the processor 254 can determine a movement type associated with a transporter user device based on the received accelerometer data. For example, the accelerometer data associated with a user operating a transporter vehicle, stopping the transporter vehicle, and walking may be associated with no acceleration and then periodic acceleration and deceleration patterns associated walking. In contrast, accelerometer data associated with a person stopping a transporter vehicle at a stoplight and then moving the transporter vehicle when the light turns green may show no acceleration followed by a somewhat constant acceleration for a period of time until the speed of the transporter vehicle is at a cruising speed. Each of these patterns of accelerometer data can be associated with a type of movement (e.g., stopping and then walking, stopping at a traffic light with it is read, and then moving after the traffic light turns green, etc.). Mappings correlating the types of movement to specific temporary transporter locations for certain end user locations can be stored in the memory 252.

The machine learning module 258C can include machine learning algorithms that can be used in conjunction with the functions performed by the location evaluation computer 250. For example, the machine learning module 258C can be programmed to determine or predict movement types from movement data from transporter user devices. The machine learning module may use supervised learning processes such as decision trees (DT), neural networks (NN), support vector machines (SVM), Gaussian mixture models (GMMs), k-nearest neighbor (KNN), naive Bayes classifiers and boosting methods. Further, the machine learning module 258C can use unsupervised learning processes to determine clusters and thereafter temporary transporter locations. Examples of unsupervised learning processes can include machine learning approaches such as the Elbow method, Bayesian Information Criterion (BIC), and/or Akaike's Information Criteria (AIC) can be applied to find the optimal number of clusters, and then k-mean and/or Gaussian Mixture Modeling (GMM) methods can be applied to find the centroid of clusters. The machine learning module 258C can also work with the other modules 258A, 258B, 258D, 258E, and 258F to facilitate processing and learning in embodiments. For example, the feedback module 258F and the processor 252 can provide feedback data to the machine learning module 258C so that the machine learning module 258C can learn and update itself.

The tagging module 258D and the processor 254 can tag the temporary transporter locations with tags based on the movement types determined by the movement type determination module 258B. For example, the movement type determination module 258B can determine that movement types associated with many transporter user devices at a very specific street location near an end user destination are all “stopping and then walking.” The specific street location may then be tagged with the label “street parking spot.” That street location may serve as a waypoint for future transporters when delivering items to the end user destination. In another example, movement types associated with many transporter user devices at a different specific street location can be stopping at a traffic light with it is red, and then moving after the traffic light turns green. This location can then be tagged with the label “traffic light.” Mappings of the specific tags, their corresponding movement types, their associated temporary transporter locations, and the particular end user location can be stored in the memory 252. In another example, temporary transporter locations for a number of transporter user devices may be spread out over a 400 square foot area and all of the determined movement types are labeled as “stopping and then walking.” This may indicate that the particular area associated with the temporary transporter locations can be tagged with a “parking lot” label.

The waypoint determination module 258E and the processor 254 can determine a waypoint associated with a specific end user destination. The waypoint determination module 258E and the processor 254 can evaluate the tags associated with the temporary transporter locations and can exclude temporary transporter locations that would not serve as suitable waypoints for future transporters to deliver items to a particular end user at an end user destination. For example, a temporary transporter location may be a traffic light, so this may not serve as a suitable waypoint. On the other hand, in the above examples, tags such as “street parking spot” or “parking lot” may be suitable waypoints for a journey to a specific end user. These temporary transporter locations may be presented to future transporters delivering items to the specific end user, and the transporter may use one of them to temporarily stop their transport vehicles when delivering an item to the end user.

In determining suitable waypoints, the direction of travel of the current transporter can be taken into account. For example, a particular temporary transporter location associated with an end user destination or location may be a suitable waypoint if the transporter is traveling from east to west. However, it may not be a suitable waypoint if the transporter is traveling from west to east.

The feedback module 258F and the processor 254 can receive feedback from transporter user devices to provide more accurate movement type labels, tags, and waypoint determinations. After presenting waypoints to transporters, the transporters can provide feedback such as confirming that the particular waypoint is a good one, or confirming that the type of waypoint had the correct tag. For example, after a transporter delivers an item to an end user, the transporter's user device may ask the transporter if the waypoint was in fact a parking lot and may ask the transporter to confirm that the waypoint was an acceptable one. The transporter can respond with answers and the machine learning module 258C, the tagging module 258D, and the waypoint determination module 258E may be updated accordingly.

The computer readable medium 258 may comprise code, executable by the processor 254, for performing a method comprising: receiving a destination address; obtaining, by the computer, historical data of transporters that previously delivered items to the destination address; determining one or more temporary transporter locations based on the historical data; determining a waypoint location from the one or more temporary transporter locations; and providing the waypoint location.

The network interface 256 can be similar to the network interface 206 and will not be repeated here.

FIG. 3 illustrates a user device 270 according to an embodiment. The user device 270 may include device hardware 274 coupled to a system memory 272.

Device hardware 274 may include a processor 276, a short range antenna 284, a long range antenna 286, input elements 280, a user interface 278, and output elements 282 (which may be part of the user interface 278). Examples of input elements may include microphones, keypads, touchscreens, sensors, etc. Examples of output elements may include speakers, display screens, and tactile devices. Exemplary input elements can include accelerometers, gyroscopes, touch screens, buttons, etc. The device hardware 274 may also include a GPS module, which can determine a GPS location of the user device 270.

The processor 276 can be implemented as one or more integrated circuits (e.g., one or more single core or multicore microprocessors and/or microcontrollers) and is used to control the operation of the user device 270. The processor 276 can execute a variety of programs in response to program code or computer-readable code stored in the system memory 272 and can maintain multiple concurrently executing programs or processes.

The long range antenna 286 may include one or more RF transceivers and/or connectors that can be used by the user device 270 to communicate with other devices and/or to connect with external networks. The user interface 278 can include any combination of input and output elements to allow a user to interact with and invoke the functionalities of the user device 270. The short range antenna 284 may be configured to communicate with external entities through a short range communication medium (e.g., using Bluetooth, Wi-Fi, infrared, NFC, etc.). The long range antenna 286 may be configured to communicate with a remote base station and a remote cellular or data network, over the air.

The system memory 272 can be implemented using any combination of any number of non-volatile memories (e.g., flash memory) and volatile memories (e.g., DRAM, SRAM), or any other non-transitory storage medium, or a combination thereof media. The system memory 272 may store computer code, executable by the processor 276, for performing any of the functions described herein.

The system memory 272 may also store an interaction application 272A a location determination module 272B, a movement module 272C, and an operating system 272D. The interaction application 272A and the processor 276 may be a delivery application such as a food delivery application. The interaction application 272A can interact specifically with the central server computer, such that the central server computer could be an application server computer. If the user device 270 is a transporter user device, then the interaction application may have code for performing the functions needed for the transporter to deliver items to the end users. For example, the interaction application could have maps which can route a transporter to an end user destination, and can show waypoints along the path to the end user destination. The location determination module 272B and the processor 406 can be used to determine a location of the user device 270. The movement module 272C may comprise code, executable by the processor 406, to generate movement data. The above described sensors (e.g., accelerometers) and the movement module 272C can produce the movement data.

Embodiments can use the systems and apparatuses described herein to at least determine provide waypoint locations specific to end user destinations to transporter user devices. Embodiments can utilize data obtained from transporter user devices to determine a waypoint location. For example, the data can include a location and a motion type. The location can be a GPS location that has be translated to longitude and latitude data. The motion type can indicate a motion type of the transporter user device at the location at a particular time (e.g., a timestamp). The motion type can be walking, driving, or stationary. In some embodiments, other motion types can also be utilized, for example, biking, public transit utilization (e.g., on a train), etc.

In embodiments of the invention, the location data from historical fulfillments can be clustered in a machine learning process to find temporary transporter locations where transporters temporarily stop when delivering an item to a particular end user or particular end user location (e.g., a specific address or a specific building). For example, these temporary transporter locations can be parking spots where the transporters parked their cars to drop-off to end users or pick up items from service providers. In such cases, the motion type of the transporter user device can change from driving to walking within a set period of time.

FIG. 5 shows a flowchart of a waypoint determination method according to embodiments. The method illustrated in FIG. 5 will be described in the context of a determining a waypoint location that is a parking location. It is understood, however, that embodiments of the invention can be applied to other circumstances (e.g., where the waypoint location is a tourist destination, a building entrance, a gated community entrance, a pickup location, etc.). The method illustrated in FIG. 5 can be performed by a computer such as the location evaluation computer 112 in FIG. 1. The steps in FIG. 5 can be described with occasional reference to the elements FIG. 1.

At step 502, an end user device can provide a destination address to a location evaluation computer 112 via a central server computer 104. The destination address can be a physical address such as a mailing address. For example, an end user device 102 can generate a fulfillment request message comprising a request for a service from a service provider. The fulfillment request message can include the destination address such as a mailing address of an end user (e.g., 123 Main St., Omaha, Nebr.). Illustratively, the fulfillment request message can be an order for food from a particular service provider operating a service provider computer 110.

After receiving the fulfillment request message, the central server computer 104 can provide the destination address and an identifier for the end user (e.g., a user ID) to the location evaluation computer 112 and the location evaluation computer 112 can receive the destination address. The central server computer 104 may have previously stored the destination address in a memory or database, or may have received it from the end user device 102. In some embodiments, the central server computer 104 can generate a waypoint request message comprising the destination address. The central server computer 104 can provide the waypoint request message to the location evaluation computer 112.

After receiving the fulfillment request message, the central server computer 104 can use the logistics platform 108 to provide a message to the service provider computer 110 to prepare the requested item. The logistics platform 108 can then determine the approximate timing of the preparation of the item by the service provider operating the service provider computer 110 and can notify the end user operating the end user device 102. The central server computer 104 can also identify a set of transporters who are able to satisfy the fulfillment request and can present an offer to satisfy the fulfillment request to those transporters (via their transporter user devices). A transporter operating a transporter user device 114 can then accept the offer to fulfill the fulfillment request. Then, the central server computer 104 can obtain the location of the transporter user device 114. The transporter location, the service provider and its location, the end user destination, and the estimated or actual times that the transporter will pick up item and deliver the item to the end user's destination can be included in the waypoint request message.

The combination of steps in 504 include processing that can occur when determining the waypoint location.

At step 506, the location evaluation computer 112 can receive the destination address (e.g., in a fulfillment request message) for an end user from the central server computer 104 as described above.

At step 508, after receiving the destination address for an end user, the location evaluation computer can obtain historical fulfillment data associated with the destination address from a fulfillment request database 106. For example, the location evaluation computer can look up the destination address in the fulfillment request database and obtain the historical fulfillment records associated with past fulfillments made to the destination address. If there is not enough historical fulfillment data associated with the received destination address, then the location evaluation computer 112 can also retrieve historical fulfillment data associated with addresses proximate to the received destination address (e.g., within 1 one block radius). The historical fulfillments may have been executed by different transporters.

The fulfillment data may also include historical data of transporters that previously delivered items to the destination address, and this data may be obtained by the location evaluation computer 112. This historical data of transporters may include the location data where transporters temporarily stopped during past trips to end user destinations. This can include the GPS location and/or latitude and longitude coordinates associated with places where the transporters temporarily stopped when delivering items to the destination address or to an address proximate to the destination address. The historical data of the transporters may also include the destination address, date and time stamps associated with deliveries to the destination address (e.g., timestamps at frequent points along paths in transporters' trips to various end user destinations), feedback received from transporters associated with the deliveries, etc.

At step 510, after obtaining the historical fulfillment data, the location evaluation computer can obtain the location data of the transporter user devices from the historical fulfillment data, as well as the location data of the transporter user device used by the identified transporter. The location data of the transporter user devices that made prior deliveries to the destination address (and optionally addresses proximate thereto) can include the times and locations of the transporter user devices as they traveled from various service providers to the destination address. For example, the time and location of a transporter user device of a transporter that delivered a food item to the end user at the end user destination may have been recorded every 30 seconds from when they pick up an item from a service provider for delivery to the time when it is delivered to the end user at the end user destination.

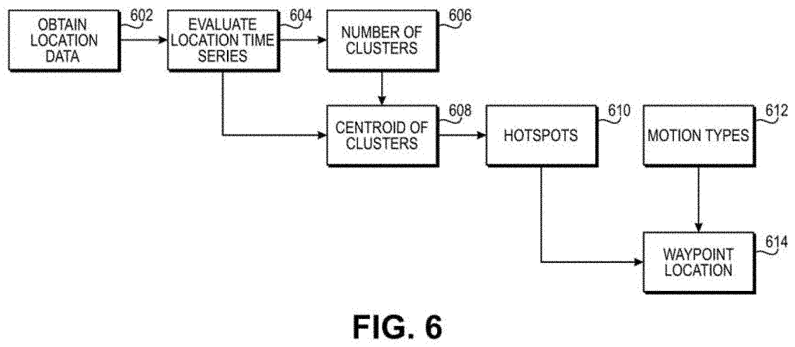

At step 512, after obtaining the location data, the location evaluation computer can perform a machine learning clustering process that clusters the location data points that indicate that a transporter user device (and therefore the transporter and the transporter vehicle) are temporarily stopped. For example, if the location data for a trip indicates that the end user device for a transporter did not change for a predetermined period of time (e.g., 10 seconds, 15 seconds, 1 minutes, 2-10 minutes, etc.), then the location corresponding to that time period may be identified as temporary stopping location for that transporter for that particular trip. Another indicator that can be used to identify a temporary stopping location may be an abrupt change in the rate of location change of a transporter user device. For instance, a user that drives, stops, and then transitions to walking may have a high rate of location change while driving and then a low rate of location change when walking. The clustering process can identify such stopping locations for many trips to the destination address by prior transporters, and can determine if the same stopping location is repeatedly observed (and therefore “clustered”). The clustering process can be an unsupervised learning process. Further details regarding the machine learning process are described in reference to FIG. 6.

At step 514, after clustering the location data, the location evaluation computer 112 can determine temporary transporter locations. For example, the location evaluation computer 112 can determine one or more temporary transporter locations based on the clusters of data described above. For example, if the historical data described above suggests that 60 percent of the past transporters temporarily stopped at a particular geographic location (e.g., X latitude, Y longitude) before delivering items to the end user's destination address, then that location can be identified as a temporary transporter location.

At step 516, after determining the temporary transporter locations, the location evaluation computer 112 can determine a motion type using a machine learning model for each temporary transporter location. The historical fulfillment data may also include motion data associated with location evaluation computer 112 can receive motion data (e.g., from an accelerometer and/or gyroscopes) and time data from the transporter user devices. The motion data associated with the times when the transporter user devices were at the temporary transporter locations can be determined. For example, a temporary transporter location may have been determined based upon time and location data from 100 trips by various transporters to the end user destination. The times associated with the temporary transporter location may be used to identify corresponding motion data generated by the transporter user devices. That motion data can be used to determine a motion type associated with that temporary transporter location. If, for example, the motion data corresponding to the temporary transporter location for 90 of the 100 trips indicates that the motion type is “stop and walk,” then that temporary transporter location can be labeled as “stop and walk.”

At step 518, after determining the motion type for each temporary transporter location, the location evaluation computer can further characterize the temporary transporter location. For example, if the motion type associated with a temporary transport location is “stop and walk,” then it can be further characterized as a “parking spot.” The further characterization can also be created using data from external sources, such as satellite maps. In step 518, the location evaluation computer 112 can determine that a temporary transporter location is a traffic light, a parking lot or parking spot, an entrance to a gated community, an entrance to a building, an entrance to a service provider location, a pickup location, etc.

For example, a temporary transporter location where transporters spend more time can be a traffic light. In such a situation, the motion type corresponding to the temporary transporter can be a transition from driving to stationary to driving. As another example, a temporary transporter where transporters spend more time can be a parking lot or parking spot. In such a situation, the motion type corresponding to the temporary transporter can be a transition from driving to walking (potentially with a short time span of stationary between driving and walking).

In some embodiments, historical or current information from other end users or other sources may confirm the location evaluator computer's characterization of the temporary transporter or may indicate that its characterization is not correct. For example, a location evaluation computer may determine that a temporary transporter location corresponds to a parking spot, but feedback from various end users may provide pictures of the location indicating that it is a traffic light.

At step 520, after determining the type of each temporary transporter location, the location evaluation computer 112 can tag the temporary transporter locations based on the determined type. For example, the location evaluation computer 112 can tag a temporary transporter location as parking. The location evaluation computer 112 can then determine waypoint locations from the tagged temporary transport locations by excluding tagged locations that would not be suitable as waypoints for the delivery of items to the destination of the end user.

At step 522, after determining the waypoint location (e.g., the temporary transporter location tagged as parking), the location evaluation computer 112 can provide the temporary transporter location to the central server computer 104. In some embodiments, the location evaluation computer 112 can generate a waypoint response message including the waypoint location. The waypoint response message can also include the tag of the waypoint location (e.g., a tag of “parking”). The location evaluation computer 112 can then provide the waypoint response message to the central server computer 104.

After step 522, the central server computer 104 can provide the waypoint location to the transporter user device 114. The transporter user device 114 can then utilize the waypoint location to navigate to the destination location using one or more modes of transportation (e.g., driving to the waypoint location from a current location, then walking to the destination location from the waypoint location).

In some embodiments, the location evaluation computer 112 can provide the waypoint location, at step 522, directly to the transporter user device 114.

FIG. 6 shows a flowchart of machine learning clustering method according to embodiments. The method illustrated in FIG. 6 will be described in the context of a clustering locations to determine temporary transporter locations. It is understood, however, that the invention can be applied to other circumstances. The method illustrated in FIG. 6 can be performed by a location evaluation computer.

To identify temporary transporter locations, embodiments can predict two outputs: 1) a number of clusters and 2) centroid(s) of clusters. FIG. 6 illustrates how to apply machine learning clustering methods to generate temporary transporter locations from GPS location data obtained from devices. Machine learning approaches such as the Elbow method, Bayesian Information Criterion (BIC), and/or Akaike's Information Criteria (AIC) can be applied to find the optimal number of clusters, and then k-mean and/or Gaussian Mixture Modeling (GMM) methods can be applied to find the centroid of clusters.

At step 602, the location evaluation computer can obtain the location data. For example, as described above, the location evaluation computer 112 can obtain the location data obtained from transporter user devices over time from fulfillments provided to a particular destination address.

At step 604, the location evaluation computer 112 can evaluate the location time series to estimate the number of clusters at step 606. For example, the location evaluation computer 112 can estimate the number of clusters using the Elbow method, Bayesian Information Criterion (BIC), and/or Akaike's Information Criteria (AIC).

At step 606, the location evaluation computer can obtain the number of clusters using the aforementioned machine learning process.

At step 608, the location evaluation computer can determine the centroid of the clusters. For example, the location evaluation computer 112 can determine the centroid using a k-mean and/or a Gaussian Mixture Modeling (GMM) method. The centroid of a cluster can be a temporary transporter location.

At step 610, the location evaluation computer 112 can collect the temporary transporter locations from each centroid.

At step 612, the location evaluation computer 112 can obtain the motion types. For example, the location evaluation computer 112 can obtain the motion types from the fulfillment request database.

At step 614, after obtaining the temporary transporter locations and the motion types, the location evaluation computer 112 can determine waypoint locations by tagging the temporary transporter locations based on the motion types. For example, if a temporary transporter location is associated with a change in motion types from driving to walking, then the temporary transporter location can be tagged as a parking spot.

The location evaluation computer can evaluate the transitions of motion type for each temporary transporter location to determine the waypoint tags. If a transporter user device motion type is driving and changed to walking, it means the transporter user device has parked their vehicle and started to go towards a location (e.g., a destination location). If a transporter user device motion type is driving and is changed to stationary, then it may mean that the transporter is driving and is stopped at an intersection or is waiting at a traffic signal.

In some embodiments, the location evaluation computer 112 can utilize additional data to determine a tag for a temporary transporter location. For example, the location evaluation computer 112 can evaluate satellite images along with the motion types to determine parking spots, building entrances, etc. The location evaluation computer 112 can also utilize reviews and tags provided by transporters. For example, a transporter can tag a location as being a parking spot using the transporter user device 114.

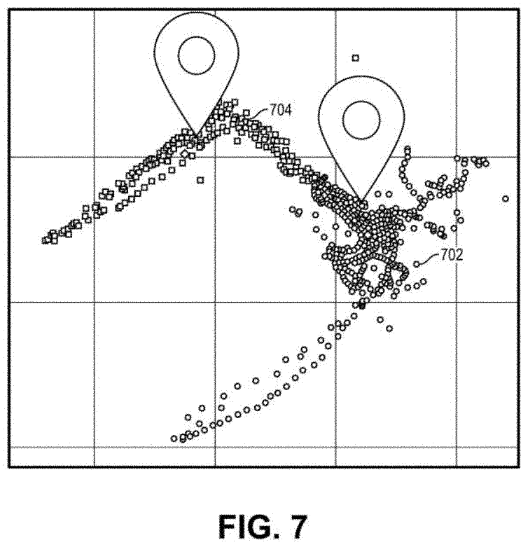

FIG. 7 shows an illustration of clustered data and determined temporary transporter locations. FIG. 7 includes a first data cluster 702 and a second data cluster 704. The data clusters can be determined by a location evaluation computer using a clustering machine learning process as described herein. Each data cluster can have a centroid. The location evaluation computer can determine the centroid. The centroid of each cluster can be a temporary transporter location.

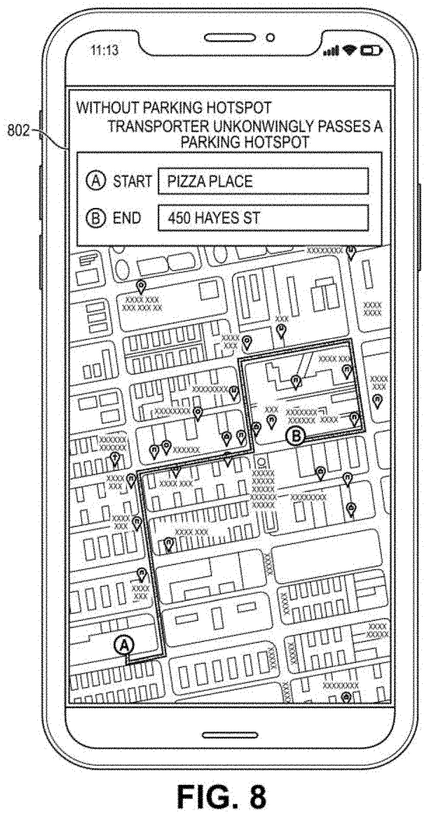

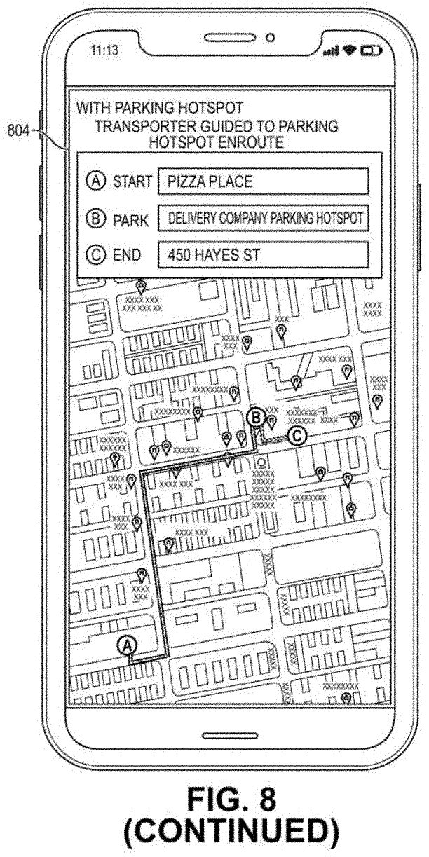

FIG. 8 shows an illustration of a navigational path with and without a temporary transporter location. FIG. 8 includes a first navigational path 802 and a second navigational path 804.

The first navigational path 802 indicates a navigational path from a starting location A to a destination location B. In the first navigational path 802 the transporter unknowingly passes a parking temporary transporter location. The transporter needs to drive a longer distance and may still need to drive after reaching the destination location B to find a parking spot according to the first navigational path 802.

The second navigational path 804 indicates a navigational path from a starting location A to a waypoint location (e.g., a parking location) B to a destination location C. The transporter can navigate directly to the parking location B prior to navigating to the destination location C. The transporter can more efficiently reach the ultimate destination location using the provided parking temporary transporter location.

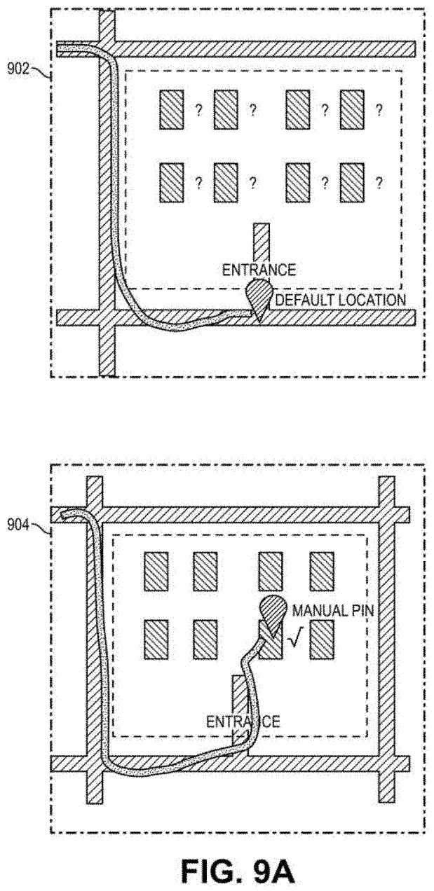

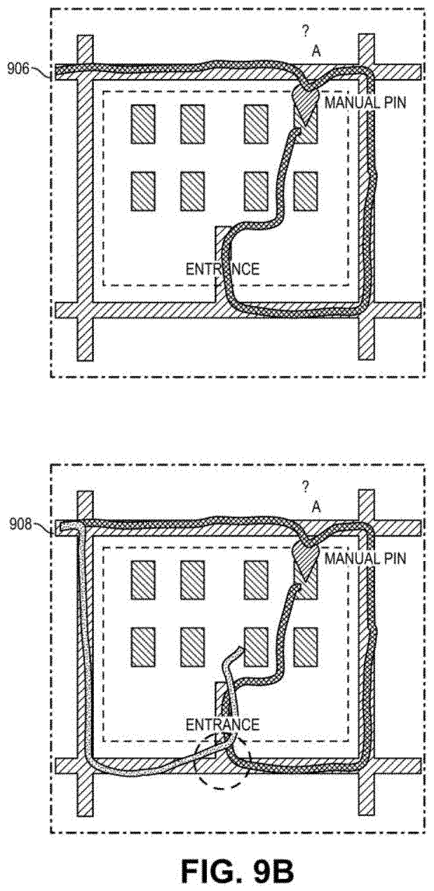

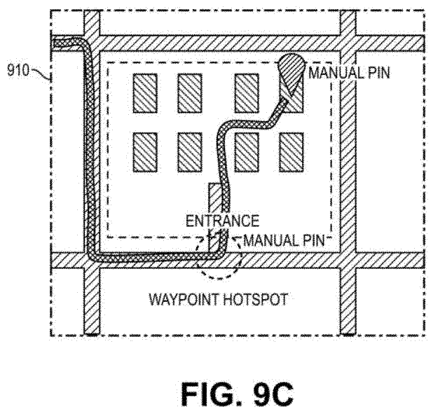

FIGS. 9A-C show illustrations of navigating to a destination location in a limited access area according to embodiments. FIGS. 9A-9C include a first navigational path 902, a second navigational path 904, a third navigational path 906, a fourth navigational path 908, and a fifth navigational path 910. Custom pinned locations can aid in situations where navigational networks do not have the precision needed to arrive at some specific end user locations.

The first navigational path 902 illustrates a default location to a gated community that has a single address. The default location address may only provide a transporter with enough navigational data to arrive at the entrance to a gated community, but not enough navigational data to arrive at the end user location.

The second navigational path 904 illustrates a custom pinned location (e.g., a manual pin) that provides the navigational precision for the transporter to find the end user location. However, there are still many situations where the custom pinned location does not create the desired change in actual routing of the navigational pathway. For example, in actuality, the custom pinned location may provide the third navigational path 906 rather than the second navigational path 904.

The third navigational path 906 illustrates a custom pinned location that causes insufficient routing change or even worse than original routing. The third navigational path 906 to the custom pinned location may route the transporter to the location A since it is near the custom pinned location. However, since this is a gated community, the transporter then needs to figure out how to get to the custom pinned location themselves. This is undesirable and poses a technical problem of how to efficiently route the navigational data to the end user location.

The fourth navigational path 908 illustrates a historic navigational path which can be leveraged, as described herein, to determine common waypoints for successful navigation. For example, historic data can indicate that many transporters navigate through the entrance area. This area can be determined to be a temporary transporter location.

The fifth navigational path 910 illustrates a navigation path that utilizes a determined waypoint. The fifth navigational path 910 routes the transporter through the entrance to the gated community (e.g., the waypoint) to the end user location (e.g., the destination location).

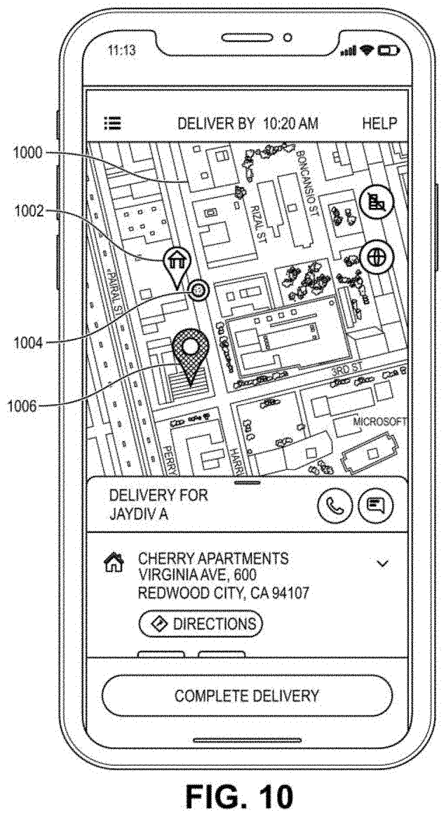

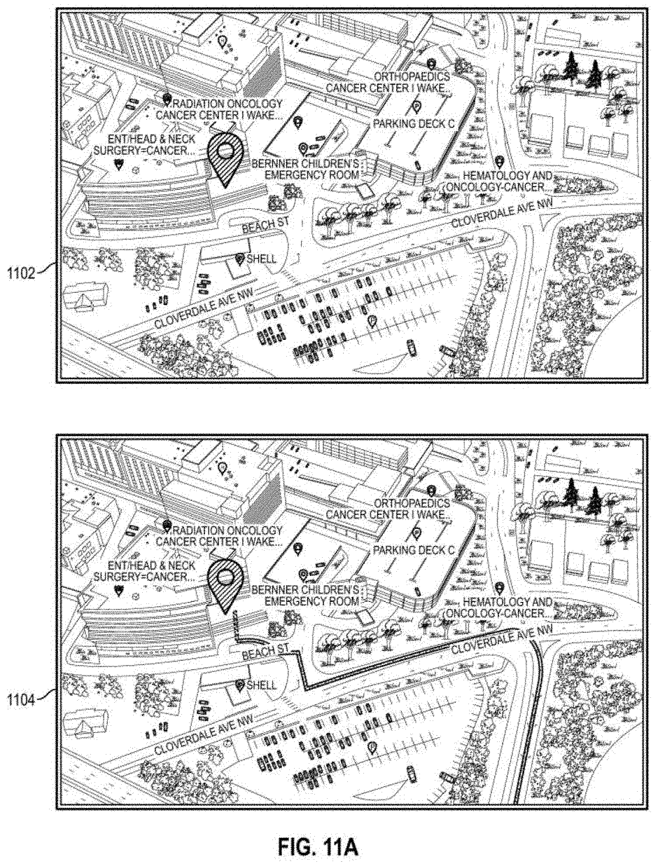

FIG. 10 shows an illustration of a destination location, a current location, and a waypoint location pinned on a map according to embodiments. FIG. 10 illustrates a satellite view of an area 1000. A destination location 1002, a current location 1004, and a waypoint location 1006 are labelled on the satellite view of the area 1000. The satellite view of the area 1000 can be obtained by the transporter when navigating to the destination location 1002. A location evaluation computer can determine the waypoint location 1006, as described herein. The waypoint location 1006, in this example, is a parking lot near the destination location 1002. The transporter can navigate from the current location 1004 to the waypoint location 1006, then navigate from the waypoint location 1006 to destination location 1002.

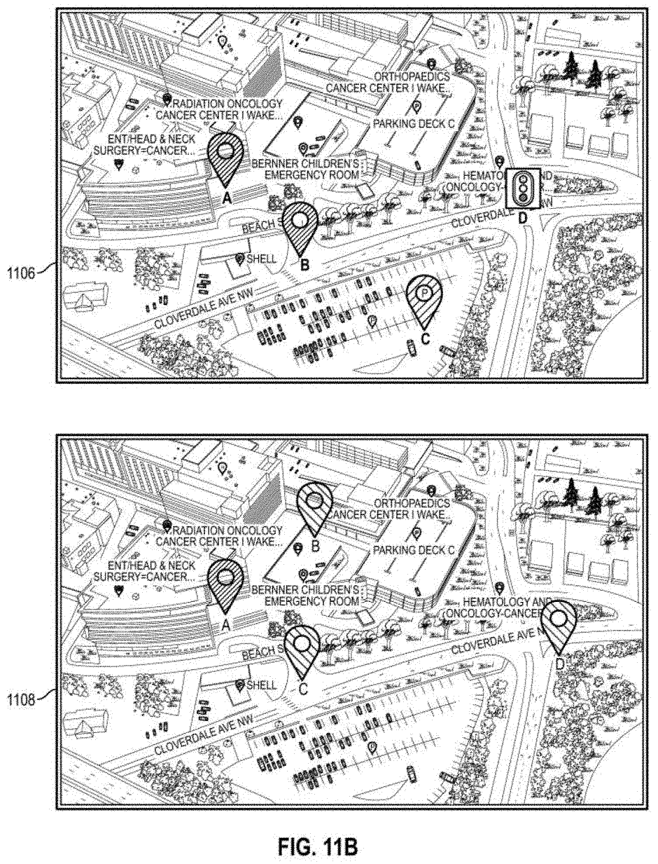

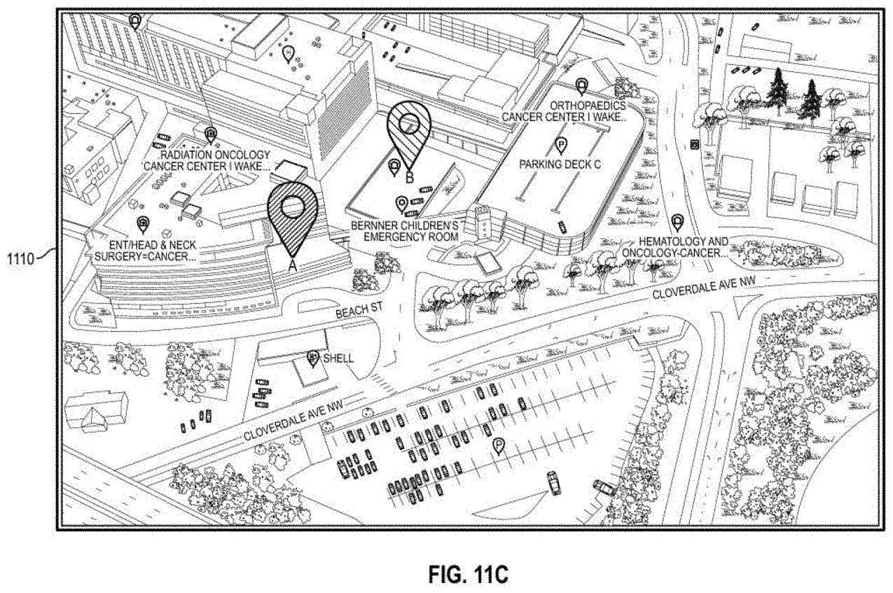

FIGS. 11A-C show illustrations of navigating to a hospital according to embodiments. FIGS. 11A-11C include a first map 1102, a second map 1104, a third map 1106, a fourth map 1108, and a fifth map 1110.

The first map 1102 illustrates a map of an area surrounding a hospital marked by a pin. The second map 1104 illustrates the map of the first map 1102 along with a navigational path that directs a navigator to the hospital. Such navigation may bring a navigator to the building itself, but does not provide additional information to the navigator about where they will actually need to navigate to before entering the hospital. For example, strictly following the navigational path presented in the second map 1104 will direct the navigator to the front of the hospital, however, the navigator should not park in front of the hospital due to safety and legal reasons. Such navigational data can be dangerous to the navigator and others at the hospital.

The third map 1106 illustrates the map of the area surrounding the hospital including several points of interest. For example, the third map 1106 includes a destination address A of the hospital, a gate entrance point B, a pre-tagged parking location C, and a traffic signal D.

The fourth map 1108 illustrates the map of the area surrounding the hospital including temporary transporter locations determined via a clustering process, as described herein. The fourth map 1108 includes the destination address A of the hospital, a parking temporary transporter location B, an entrance temporary transporter location C, and a stop light temporary transporter location D.

The fifth map 1110 illustrates the map of the area surrounding the hospital including a determined parking spot waypoint location B. The fifth map 1110 includes a parking spot waypoint location B that is closer to the destination address A than the pre-tagged parking location C of the third map 1106.

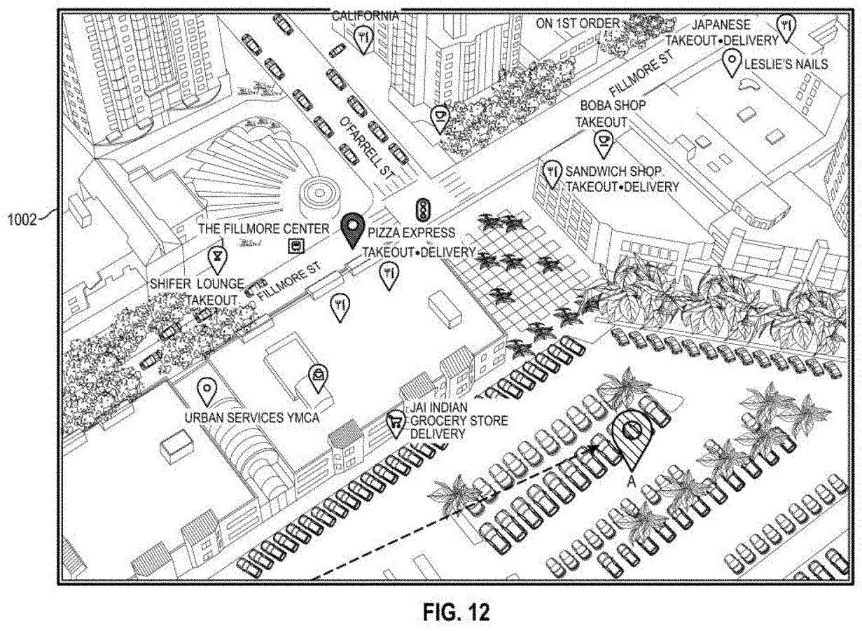

FIG. 12 shows an illustration of a shared waypoint according to embodiments. FIG. 12 includes a map that illustrates a shared waypoint location A. The shared waypoint location A can be a parking waypoint location for more than one service provider location. For example, the transporter can access one or more service provider locations when parked at the shared waypoint location A.

Embodiments of the disclosure have a number of advantages. For example, embodiments provide for allowing transporters to find parking faster when transporting. Furthermore, embodiments provide for a smaller distance to be travelled by eliminating extra driving by transporters trying to find a parking location or and entrance location. The waypoint provided by the location evaluation computer is accurate can allow the transporters to navigate to the waypoint for parking (or to find an entrance) prior to navigating to the destination location.

Reducing the distance travelled is beneficial because it reduces the amount of greenhouse gases emitted into the air by transporter vehicles. Furthermore, reducing the distance travelled is beneficial because if allows the transporter to arrive at the destination location sooner to deliver time sensitive parcels, thus reducing waste. Still further, eliminating the need for the transporter to be constantly re-routed to an end destination, because they cannot locate a suitable place to temporarily stop, saves on computing resources since additional re-routing computations needed not be performed by applicable computer systems. Also, embodiments of the invention can help reduce the carbon footprint of transporters, since they don't have to spend time trying to find temporary stopping locations such as parking spots.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents. For example, many of the specific examples above relate to a waypoint that is a parking spot and a destination address that is an end user address. Embodiments are not limited thereto. For instance, waypoints can include gates at complexes, entrances to buildings, and other types of locations. Further destination addresses can also include addresses of service providers that are providing items to be delivered.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a computer, a destination address;
obtaining, by the computer, historical data of transporters that previously delivered items to the destination address;
determining, by the computer, one or more temporary transporter locations based on the historical data of transporters;
determining, by the computer, a waypoint location from the one or more temporary transporter locations; and
providing, by the computer, the waypoint location.

2. The method of claim 1, wherein the computer is a location evaluation computer, the destination address is received from a central server computer, and the waypoint location is provided to the central server computer or a transporter user device.

3. The method of claim 1, wherein determining the one or more temporary transporter locations further comprises:
performing, by the computer, a machine learning clustering process to cluster the historical data of transporters that previously delivered items to the destination address to obtain the one or more temporary transporter locations, wherein the historical data of transporters that previously delivered items to the destination address comprises time based location data associated with a plurality of transporters.

4. The method of claim 1, wherein determining the waypoint location from the one or more temporary transporter locations comprises:
determining, by the computer, a motion type for each temporary transporter location of the one or more temporary transporter locations;
determining, by the computer, a tag for each temporary transporter location based on the motion type; and
if the tag for a temporary transporter location meets waypoint location criteria, then determining that the temporary transporter location is the waypoint location.

5. The method of claim 1, wherein the historical data of the transporters comprises location data and motion data associated with transporter user devices associated with the transporters.

6. The method of claim 1, wherein determining the one or more temporary transporter locations further comprises:
performing, by the computer, a machine learning clustering process to cluster the historical data of the transporters to obtain the one or more temporary transporter locations, wherein the historical data comprises location data of transporter user devices of the transporters when the transporter user devices are temporarily motionless during the delivery of items to the destination address.

7. The method of claim 6, wherein the location data of the transporter user devices comprises latitude and longitude data of the transporter user devices.

8. The method of claim 7, wherein determining the waypoint location from the one or more temporary transporter locations comprises:
determining, by the computer, a motion type for each temporary transporter location of the one or more temporary transporter locations;
determining, by the computer, a tag for each temporary transporter location based on the motion type; and
if the tag for a temporary transporter location meets waypoint location criteria, then determining that the temporary transporter location is the waypoint location.

9. The method of claim 8, wherein determining the motion type for each temporary transporter location comprises evaluating motion data associated transporter user devices at the temporary transporter location to determine the motion type.

10. The method of claim 9, wherein the motion data associated with transporter user devices comprises accelerometer data.

11. The method of claim 9, wherein the destination address is a physical address.

12. The method of claim 1, wherein the waypoint location is provided to a transporter user device that is held by a transporter that operates a transporter vehicle.

13. The method of claim 12, wherein the transporter vehicle is a car.

14. The method of claim 1, wherein the waypoint location is provided to a transporter user device that is part of a transporter vehicle, the transporter vehicle being an autonomous car, drone, or cart.

15. The method of claim 1, wherein determining the one or more temporary transporter locations further comprises:
performing, by the computer, a machine learning clustering process to cluster the historical data associated with the destination address to obtain the one or more temporary transporter locations.

16. A computer comprising:
a processor; and
a computer-readable medium coupled to the processor, the computer-readable medium comprising code executable by the processor for implementing a method comprising:
receiving a destination address;
obtaining historical data of transporters that previously delivered items to the destination address;
determining one or more temporary transporter locations based on the historical data;
determining a waypoint location from the one or more temporary transporter locations; and
providing the waypoint location.

17. The computer of claim 16, wherein determining the one or more temporary transporter locations further comprises:
performing a machine learning clustering process to cluster the historical data associated with the destination address to obtain the one or more temporary transporter locations, wherein the historical data comprises location data of transporter user devices used by transporters that are temporarily motionless,
wherein the location data comprises latitude and longitude data of the transporter user devices; and
wherein determining the waypoint location from the one or more temporary locations comprises:
determining, by the computer, a motion type for each temporary transporter location of the one or more temporary transporter locations;
determining, by the computer, a tag for each temporary transporter location based on the motion type; and
if the tag for a temporary transporter location meets waypoint location criteria, then determining that the temporary transporter location is the waypoint location.

18. A system comprising:
a computer comprising:
a processor; and
a computer-readable medium coupled to the processor, the computer-readable medium comprising code executable by the processor for implementing a method comprising:
receiving a destination address;
obtaining historical data of transporters that previously delivered items to the destination address;
determining one or more temporary transporter locations based on the historical data;
determining a waypoint location from the one or more temporary transporter locations; and
providing the waypoint location to a user device used by a transporter;
wherein determining the one or more temporary transporter locations further comprises:
performing, by the computer, a machine learning clustering process to cluster the historical data associated with the destination address to obtain the one or more temporary transporter locations, wherein the historical data of transporters that previously delivered items to the destination address comprises location data of transporter user devices used by the transporters that are temporarily motionless,
wherein the location data comprises latitude and longitude data of the transporter user devices; and
wherein determining the waypoint location from the one or more temporary locations comprises:
determining, by the computer, a motion type for each temporary transporter location of the one or more temporary transporter locations;
determining, by the computer, a tag for each temporary transporter location based on the motion type; and
if the tag for a temporary transporter location meets waypoint location criteria, then determining that the temporary transporter location is the waypoint location; and
the user device.

19. The system of claim 18, wherein the transporters are automobiles.

20. The system of claim 18, wherein the user device is a mobile phone.
